(19) United States
(12) Patent Application Publication
(10) Pub. No.: US 2018/0184652 A1
(43) Pub. Date: Jul. 5, 2018

(54) PYROLIGNEOUS ACID INSECT REPELLENT

(71) Applicants: The United States of America, as represented by the Secretary of Agriculture, Washington, DC (US); Corigin, LLC, Livermore, CA (US)

(72) Inventors: Spencer S. Walse, Fresno, CA (US); Michael R. Woelk, Livermore, CA (US)

(21) Appl. No.: 15/395,052

(22) Filed: Dec. 30, 2016

(51) Int. Cl. A01N 37/02; A01N 35/02; A01N 31/02

(52) U.S. Cl. CPC A01N 37/02; A01N 31/02; A01N 35/02

(57) ABSTRACT

Disclosed are methods for protecting a tree or plant or harvest product from acquiring a plant pathogen carried by insects through the application of pyroligneous acid composition diluted in water. The methods include subjecting a lignocellulosic biomass to a pyrolysis process and passing an exhaust gas of the pyrolysis process through a condensing column thereby producing the pyroligneous acid composition. The composition is applied to objects, areas, or the surfaces of trees or plants to repel the insects thereby minimizing production loss and preventing the tree or plant or harvest product from acquiring the plant pathogen.

### FIELD OF THE INVENTION

The disclosed invention relates generally to novel methods of repelling insects from agricultural areas. More particularly, the invention relates to methods of repelling insect pests from agricultural areas using an insect repellant composition including pyroligneous acid to prevent production losses and crop disease.

### BACKGROUND OF THE INVENTION

The value of crops is significantly impacted by direct insect damage as well as diseases carried and spread by contact with insects Eliminating insect pests from production areas minimizes these impacts and helps ensure the safe movement of agricultural products through domestic and global marketing channels. Practical and novel alternatives to existing insect pest control technologies, such as repellants, offer potential to alleviate relatively expensive conventional chemical applications and postharvest treatments as well as reduce the environmental and ecological impact of such treatments. On a global scale, progress in the ability to safely produce insect-free commodities contributes positively to food security and food safety. Examples of particular concern in relation to the present invention include Asian Citrus Psyllids and Navel Orangeworms, which are key insect pests of the California citrus and tree nut industries, repsectively.

The Asian Citrus Psyllid, Diaphorina citri, (ACP) resembles a miniature cicada and is sometimes referred to as a jumping plant louse. ACP is approximately 3 to 4 mm long with a typically light brown coloration and appears dusty due to a waxy secretion covering the body. Adult psyllids are able to transmit a pathogen that causes “citrus greening” and infect a new tree in as little as 15 minutes of feeding. Psyllids may acquire the citrus greening pathogen after feeding on an infected plant for as little as 15 to 30 minutes, or may also acquire the pathogen if it grew from an egg lain on a diseased tree. Psyllids lay their eggs on tips of growing shoots on and between unfurling leaves a single female psyllid is typically capable of laying more than 800 eggs during its life. ACP play a key role in spreading Candidatus Liberibacter spp. (e.g., asciaticus, americanus, and africanus), a genus of gram-negative bacteria responsible for citrus greening, aptly named “Huanglongbing” (HLB). It is a systemic and invasive disease with symptoms including stunted growth, sparsely foliated branches, unseasonal blooming, premature leaf and fruit drop (with fruits on infected trees being small, lopsided, underdeveloped, unevenly colored, hard, and poor in juice), and dieback. Trees generally do not survive beyond 4-6 years after initial infection and there is no cure for the disease. Young trees are particularly susceptible to greening disease and may die only 2 years after initial infection and normally never become productive.

The Navel Orangeworm, Amyelois transitella, (NOW) is the major insect pest in California affecting tree nuts (e.g., almonds, pistachios, walnuts, etc.); however, other types of fruits can serve as hosts (e.g., figs, pomegranate). Feeding damage by NOW larvae lowers product quality resulting in extensive economic loss to the tree nut industry. Moreover, feeding damage directly contributes to contamination by ubiquitous orchard fungi that are the principle cause of decay (e.g., Alternaria alternata, Botrytis cinerea, Fusarium spp., Stemphylium spp., Penicillium spp., Cladosporium herbarum, Aspergillus spp.). It is important to note the role of Aspergillus spp. in producing aflatoxins—a serious food safety problem due to their carcinogenic and teratogenic attributes (see Campbell et al., 2003; Robens and Cardwell, 2003). Thus, products infested with navel orangeworm are unmarketable and create great economic stress for industry.

Currently, there are few, if any, commercial products for repelling insect pests from nut trees and citrus trees. This lack is due, in large part, to reliance on conventional pesticides for control, which in turn creates environmental and health risks associated with such pesticides. The use of broad-spectrum, persistent insecticides has significant drawbacks in that the chemicals also kill other beneficial insects and may contaminate surface waters due to runoff as well create other environmental concerns. The total economic impact of fruit and nut crops in California alone is $20B or more. Insect repellant technology for the agricultural industry has a potential global market that includes growers of fresh fruit types as well as local, regional, and national governments There thus exists a substantial need for the development of economically favorable formulations to repel or control insect pests in plants and crops including nut and fruit trees with reduced environmental and health concerns. In addition, there exists a need for the development of effective and sound management strategies to reduce the spread of disease-causing pathogens, reduce pest damage in post-harvest commodities, limit the spread of exotic pests, and ensure competitiveness in the international commerce of agricultural products.

### SUMMARY OF THE INVENTION

This invention accordingly provides novel methods of repelling insects in orchard environments through the application of aqueous pyroligneous acid (PLA) solutions to an object or area. In a main aspect, the present invention describes the use of aqueous dilutions of PLA for use as repellents to discourage insect infestation on trees and plants. In an exemplary embodiment, the present invention describes the use of aqueous dilutions of PLA as repellents to discourage insect infestation in agricultural environments such as citrus production orchards and tree nut farms.

In an aspect, the present invention provides a method of repelling at least one insect pest. The method comprises applying to an object or area an effective amount of a repellant composition comprising PLA and optionally combining the repellant composition with a carrier. The effective amount of the repellant composition is effective to reduce the at least one insect pest on the area.

In an aspect, the present invention provides a method of protecting a tree, a plant, or a harvest product from acquiring a pathogen carried by an insect. The method includes treating at least one surface of the tree, plant, or harvest product with an aqueous dilution of a repellant composition comprising PLA.

In an aspect, the present invention provides a method for protecting a tree or a harvest product of the tree from acquiring a plant pathogen carried by at least one insect. The method includes subjecting a lignocellulosic biomass to a pyrolysis process and passing an exhaust gas of the pyrolysis process through at least one condensing column. A pyroligneous acid composition is thereby produced. The concentration of the pyroligneous acid within the produced pyroligneous acid composition is determined and diluted in water to result in the concentration of pyroligneous acid from about 0.001% to about 1% (v/v) to produce an insect repellant composition. In another aspect, the insect repellant composition comprising PLA may be used in undiluted form. The insect repellant composition is applied to at least one surface of a tree in an amount sufficient to repel the insect thereby preventing the tree from acquiring the plant pathogen.

It is an advantage of the invention to provide a method of repelling disease-causing pathogen-carrying insects from agricultural areas as well as harvest product storage and transportation areas.

It is a further advantage of the present invention to provide proprietary methods of protecting trees including citrus trees and nut trees as well as other plants from acquiring pathogens that cause disease destructive to such trees, plants, and harvest products.

It is an additional advantage of this invention to provide methods of producing pyroligneous acid for application as insect repellants for agricultural industry usage.

It is yet another advantage of the present invention is to provide an economical and environmentally sustainable method of repelling insects from agricultural areas as well as harvest product storage and transportation areas.

It is also an advantage of the invention to provide a method increasing egg mortality thereby controlling the population increase of certain insects.

Another advantage of the invention is to provide an insect repellant product produced from lignocellulosic residues which meets the requirements for organic certification.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

FIG. 1A-1B show the difference in temporal NOW flight response and ovipositional response, respectively, to olfactory cues from almonds at hull-split following treatment with PLA as further described below.

### DETAILED DESCRIPTION OF THE INVENTION

Unless herein defined otherwise, all technical and scientific terms used herein generally have the same meaning as commonly understood by one of ordinary skill in the art to which this invention belongs. The definitions below may or may not be used in capitalized form herein and are intended to be used as a guide for one of ordinary skill in the art to make and use the invention and are not intended to limit the scope of the invention. Mention of tradenames or commercial products is solely for the purpose of providing specific information or examples and does not imply recommendation or endorsement of such products.

“ACP” as used herein refers to the Asian Citrus Psyllid, Diaphorina citri.

“Carrier” as used herein refers to any method of dispersal, dispensation, application, timed-release, encapsulation, microencapsulation, or the like to apply the insect repellant composition as further described herein. In embodiments, such “carriers” may include a variety of microencapsulation, controlled-release, and other dispersion technologies available to those of ordinary skill in the art.

“Citrus tree” as used herein refers to any species of tree producing any variety of citrus fruit, such as oranges, tangerines, clementines, lemons, limes, and the like.

“Control” or “controlling” as used herein refers to any means for preventing infection or infestation, reducing the population of already infected areas, or elimination of insect pest population(s) whose “control” is desired. Indeed, “controlling” as used herein refers to any indicia of success in prevention, elimination, reduction, repulsion, or amelioration of a pest population or pest problem.

“Insect” or “insect pest” as used herein means any variety of insects that may cause harm to plants, trees, fruits, or nuts or products produced thereby or therefrom. In exemplary embodiments, such pests include NOW and ACP.

“NOW” as used herein refers to the Navel Orangeworm, Amyelois transitella.

“Object” or “Area” as used herein may include any place where the presence of target pests is not desirable, including any type of premises, which can be out-of-doors, such as in agricultural areas (e.g., plants, trees, storage facilities, transportation vessels), gardens, lawns, tents, camping bed nets, camping areas, and so forth, or indoors, such as in barns, garages, commercial buildings, homes, and so forth, or any area where pests are a problem, such as in shipping or storage containers (e.g., bags, boxes, crates, etc).

“Ovipositional disruption” as used herein means distracting or otherwise discouraging a female insect from laying eggs in the usual host plant location (e.g., almond fruit) and may optionally involve encouraging her to instead lay her eggs in a non-viable location (e.g., an egg trap) in which the resulting larvae do not survive.

“Pathogen” or “Plant Pathogen” as used herein refers to any disease-causing microorganism carried by an insect pest and transmitted to a tree or plant or its harvest products (e.g., fruit, citrus, nuts) that causes harm to the tree or plant or its harvest products resulting in economic loss to the agricultural industry.

“Pyroligneous acid” or “PLA” as used herein refers to a broad class of acid liquor produced from the destructive distillation of lignocellulosic biomass. For example, the principle components of the acid liquor are typically acetic acid, acetone, and methanol as well as other compounds which vary depending on the source of the lignocellulosic biomass.

“Ratio” as used herein, refers to the relative proportion of at least two compounds with respect to one another. Typically, the term “ratio” refers to the relative number of moles (molar ratios) present of each compound or to the mass or volume ratios, as applicable.

“Repel” or “Reduce” as used herein refers to any indicia of success in the diminishment in size, amount, extent, presence, reproductive capacity, lifespan, and/or severity of insect pest infestation. For example, an insect repellant is any compound or composition which deters insects from a host. Thus the term “repel” may be defined as causing insect pests (e.g., NOW and ACP) to make oriented movements away from a source of a chemical repellent and also may include inhibiting feeding, breeding, or ovipo siting of such insects when a chemical is present in a place where insects would, in the absence of the chemical, feed, breed, or oviposit. Thus the term “repel” also includes reducing the number of insect pests on a treated area or object when compared to the same area or object which is untreated.

“Tree nuts” as used herein refers in its broadest sense to include any nut, drupe, or fruit produced by trees. Exemplary “tree nuts” include, but are not limited to pistachio nuts, almonds, Brazil nuts, pine nuts, chestnuts, walnuts, pecans, and the like.

Repellency of PLA against insect pests was demonstrated in laboratory-scale research trials as shown in the examples below. For instance, applications of aqueous PLA to almonds undergoing hull split retarded the capture of female NOW as well as inhibited egg laying in flight tunnel bioassays. In a two-choice feeding deterrent study, applications of aqueous PLA to citrus saplings inhibited the infestation of ACP. Local, regional, and national governments mandate a number of regulatory measures to reduce risks associated with movement of the host commodities, for example, from NOW and/or ACP infested areas, ranging from outright prohibition to requiring quarantine treatments. The present invention is advantageous to avoid such negative outcomes.

In embodiments, aqueous solutions of pyroligneous acid (PLA) are applied for postharvest control of insect pests in citrus fruits. In other embodiments, the repellant composition is applied to seeds, seedlings, plantlets, saplings, and/or adult trees or plants. In a preferred embodiment, the repellant composition is applied to one or a plurality of trees in an agricultural setting. In other embodiments, the repellant composition is applied to plant material subject to infestation, including citrus trees and nut trees.

In various embodiments, the repellant composition may be applied in any form known in the art. The compounds according to the invention, which can be used in undiluted or diluted form, can be converted into formulations customary for repellents. They can be used in all the presentation forms customary in industry, for example, in the form of solutions, emulsions, gels, sprays, and the like. For example, a foliar spray may be used as well as aqueous sprays, atomizing sprays, aerosols, and fogs with or without a carrier to treat objects or areas. The repellant composition may also be applied to plants in residential, greenhouse, harvest product storage areas as well as transportation vessels and area, agricultural settings, and other objects or areas according to alternative embodiments.

In an embodiment, the invention is a method of protecting a tree from acquiring a pathogen carried by an insect. At least one surface of a tree is treated with or exposed to an aqueous dilution of a repellant composition comprising pyroligneous acid. In alternative embodiments, the repellant composition of the invention is applied to a tree such as a citrus tree capable of bearing fruit including oranges, tangerines, clementines, lemons, limes, and the like. The ACP is of particular concern for citrus fruits because it carries a pathogen known to cause citrus greening as further described herein. The application of the repellant composition is not, however, limited to treatment directed toward the ACP in citrus tree environments and may be directed to a plurality of insect species. In specific embodiments, the repellant composition is effective as a treatment against at least one insect species including ACP, NOW, the like, and combinations thereof.

In an embodiment, the present invention provides a method of repelling at least one insect pest. The method comprises applying to an area an effective amount of a repellant composition comprising pyroligneous acid. In an embodiment, the aqueous dilution of the repellant composition comprises an amount of pyroligneous acid sufficient to repel an insect to prevent transfer of a pathogen (e.g., Aspergillus flavus, Aspergillus parasiticus, Candidatus Liberibacter asiaticus) from the insect to a tree or plant or its harvest products.

Preferably, the PLA concentration effective as an insect pest repellant are aqueous dilutions about 0.001% to about 1.0% (v/v) in water. As further discussed herein, PLA is a solution comprised of a mixture of organic acids, phenolics, and water and ratios of constituents and composition will vary depending on the production methods and biomass feedstock. A 1% solution, therefore, is about 1% PLA and about 99% water. The final total water fraction will be more than 99% as a result of the other components present in the undiluted PLA composition. In other embodiments, the PLA fraction may be as high as 10% vol/vol with the remaining portion being preferably water.

The amount of pyroligneous acid used depends on the particular application as determined by one of ordinary skill in the art and dependent on factors such as insect species, plant/tree type, product type, environmental conditions, and the like. It was, however, unexpectedly and surprisingly discovered that relatively low concentrations of PLA were highly effective in the method of the invention. In an exemplary embodiment, the amount of PLA used is from about 0.001% to about 1% (v/v) pyroligneous acid diluted in water. In an embodiment, the PLA fraction is from about 0.0001 to about 10 v/v % (e.g., 0.0001 to 10 v/v %. In a preferred embodiment, the PLA fraction is from about 0.001 to about 10 v/v % (e.g., 0.001 to 10 v/v %). In another preferred embodiment, the PLA fraction is from about 0.001 to about 1 v/v % (e.g., 0.001 to 1 v/v %. In various embodiments, the amount of PLA in the aqueous dilution is (all based on a v/v % dilution) 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99, or 1.0. It should be appreciated that increased fractions of PLA may also be used including (v/v % dilution in water), for example, 1.5, 2, 2.5, 3, 3.5, 4, 4.5, 5, 5.5, 6, 6.5, 7, 7.5, 8, 8.5, 9, 9.5, or 10% solution of PLA.

Pyroligneous acid (PLA) (sometimes referred to as wood vinegar or wood acid) is a condensed liquid produced by the pyrolysis of lignocellulosic biomass (e.g., wood and other plant materials). Lignocellulosic biomass, regardless of source, generally comprises three major components including cellulose, hemicellulose, and lignin. Cellulose and hemicellulose are carbohydrate polymers, and lignin is a complex phenolic polymer. PLA typically contains over 200 minor compounds including chemicals that some plants naturally produce to protect against chewing insects, plant growth stimulants, organic acids, alcohols, miscellaneous organics and water. The major constituents are acetic acid, acetone and methanol. It should be appreciated that the dilution strength of the PLA produced through the method of the invention varies considerably depending on the source of the lignocellulosic biomass. When almond shells, for example, are used as feedstock the produced PLA is thought to be relatively low in organic acid and phenolic compounds in comparison to PLA produced from pine wood shavings.

Any lignocellulosic biomass may be used as feedstock to produce PLA for use in this invention; however, the fractions of water, organic acid, and phenolics may vary as well as the molecular composition of the organic acid and phenolic fractions. The particular source of feedstock is typically not critical. Examples of lignocellulosic biomass feedstock include almond shells, pine wood shavings, barks, grasses, fruit pits, stems, roots, leave, the like, and combinations thereof.

In preparing the PLA from the lignocellulosic biomass, any method known in the art may be employed. Generally, the lignocellulosic biomass is heated in an oxygen-reduced environment leading to the thermal decomposition of the biomass and release of gases. The gases (sometimes referred to as exhaust smoke) are condensed into a liquid and separated into fractions of tar, pyroligneous acid, and bio-oil. The equipment used for PLA production can vary, for example, from basic metal drums or in ground fire pits to state of the art industrial processors that are computer-controlled continuous biomass converters.

Typically, the pyroligneous acid for use in the invention is derived from the pyrolysis of a lignocellulosic biomass and the exhaust smoke is passed through at least one condensing column. An exemplary method of producing PLA is through the use of one or more condensing columns. During pyrolysis of the lignocellulosic biomass, the exhaust smoke containing steam, organic vapor, and non-condensable gases enter a first packed-bed condensing column where the compound are cooled down from approximately 450° C. to a temperature varying between 60 to 80° C. under reduced pressure. The residence time within the first column is short. The heavier bio-oil portion may be collected at the bottom of the condensing column if desired. The lighter portion of the liquid blend (i.e., the portion containing the pyroligneous acid) inside the first condensing column is withdrawn and directed towards a second condensing column. The second condensing column operates at a slightly lower temperature than the first condensing column. PLA is recovered at the bottom of the second condensing column. This liquid stream is rich in water, phenolic compounds, low molecular weight carboxylic acids, and aldehydes/ketones.

In other embodiments, PLA is produced with crude methods and may contain phytotoxic heavy oils. In such embodiments, a single vapor mixture resulting from the pyrolysis of the lignocellulosic biomass is cooled to liquid and subsequently allowed to settle over a long time period (e.g., 2 to 3 months) whereby heavy oils precipitate as tars and PLA is decanted. This method of PLA production is not preferred, but may be used to produce PLA for use in the method of the invention.

In embodiments, prior to diluting with water the ratio of chemical constituents in the produced PLA composition is determined with gas chromatographic or mass spectrometric techniques. In other embodiments, any methods of analytical chemistry generally known in the art may be used to determine the constituents and ratios. It is contemplated for preferred embodiments that the presence of certain phenolic compounds are of critical importance for the effectiveness of the invention.

The repellent compositions of the present invention may also contain carriers, carrier materials, emulsifiers, or diluents as known to one of ordinary skill in the art. Carriers or diluents as contemplated herein are generally inert materials used in making different formulations of the repellent compositions of the present invention. The specific carrier used in any repellent composition depends on the particular application of the repellent composition. For example, the carrier or carrier material may be, for example, agronomically, physiologically, or pharmaceutically acceptable carriers or carrier materials. The carrier component can be a liquid or a solid material. As is known in the art, the vehicle or carrier to be used refers to a substrate such as water, membranes, hollow fibers, microcapsules, filters, gels, polymers, or the like. All of these substrates have been used to release insect feeding deterrent/repellents in general and are well known in the art.

In some exemplary embodiments, the disclosed PLA composition is applied with a carrier. In one embodiment, the PLA is encapsulated (e.g., microencapsulated), by methods known in the art (see e.g., Bakan, J. A. Microencapsulation Using Coacervation/Phase Separation Techniques. In Controlled Release Technology: Methods, Theory, and Application; Kydonieus, A. F., Ed.; CRC Press: Boca Raton, Fla., 1980; pp 83-105; and Herbig, S. M, et al. (1987) Am. Chem. Soc. Div. Polym. Chem. Prepr. 1987, 28, 92-9, each of which are incorporated herein in their entirety by reference). In other embodiments, any suitable method known in the art, however, for dispersal/dispensation/application/timed-release of the PLA composition disclosed herein for repelling insect pests may be used in the implementation of the invention.

In an aspect of the invention, aqueous solutions of PLA are useful repellents as part of biosustainable integrated pest management practices, for example, directed to NOW control in tree nut orchards as well as in ACP control in citrus orchards thereby potentially alleviating or mitigating the need for relatively expensive conventional chemical applications as well as postharvest quarantine treatments. In various embodiments, the PLA compositions of the invention may also be combined with conventional pesticides or biopesticides for widespread application. Such pesticides and biopesticides are known and regularly developed in the art and may be selected, if needed for certain applications, by one of ordinary skill in art for use in conjunction with the repellant composition of the present invention.

In various embodiments, the repellent compositions of the invention optionally include anti-microbial agents to enhance the reduction of transfer of infectious diseases. As one with ordinary skill in the art will understand, any anti-microbial agents appropriate for application to the specific target areas to be treated may be used. For example, a plethora of anti-microbial agents are used in the agricultural industry and any one or more of such agents may be appropriate for use in the present invention as determined by a user having ordinary skill in the art.

In embodiments, the repellent compositions herein disclosed optionally include an antioxidant or other preservative agent to assist in preventing the rancidity of oils and fats that may be present in the compositions. As one with skill in the art will understand, any suitable antioxidant appropriate for application to the specific target area to be treated may be used. For example, many antioxidant and preservative agents are used in the agricultural industry and any one or more of such agents may be appropriate for use in the present invention as determined by a user having ordinary skill in the art.

Other compounds (e.g., insect attractants or insecticidal compounds known in the art) may also be used in conjunction with the disclosed composition provided they do not substantially interfere with the intended activity and efficacy of the composition; whether or not a compound interferes with activity and/or efficacy can be determined, for example, by the procedures utilized below. Such other compounds may be added to or used in addition to the PLA composition for use in the disclosed invention as deemed appropriate a skilled artisan.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurement. The following examples are intended only to further illustrate the invention and are not intended in any way to limit the scope of the invention as defined by the claims.

### EXAMPLES

### Example 1

### Naval Orangeworm

In this example, the insecticidal efficacy and/or repellency of PLA towards key pests of tree nuts in production scenarios (e.g., foliar & aerial applications) was determined. In particular, PLA-mediated inhibition of the NOW flight-response to olfactory cues from almond hulls was tested in developing an ovipositional deterrent for field applications.

NOW is the primary lepidopteran pest of almonds in California. It is controlled in orchards by a combination of sanitation and insecticides. NOW females are known to oviposit on almonds, with a pronounced increase concomitant with the onset of hull-split, a period of senescence that precedes harvest by approximately 30 days. The flight-response of NOW females to olfactory cues from almonds was bioassayed in a flight-tunnel and comparatively evaluated relative to almonds treated with PLA. Work was conducted in the context of identifying the potential for PLA to inhibit the flight-response of NOW toward almonds, as application of a potent repellent in orchards at the time of hull-split has marked potential to reduce NOW oviposition, and subsequent infestation. Female NOW flight-response to hull-split volatiles was evaluated over consecutive days following the treatment of almonds with a 0.01% aqueous solution of PLA. Female NOW attraction to treated almonds was initially suppressed, and took 5 to 6 days to return to levels expected for untreated almonds.

Flight Chamber Construction. Two Plexiglas flight chambers (0.61×0.61×2.13 m) (Analytical Research Systems, Gainesville, Fla., Model #OLFM-WT-24×24×84) were used concurrently. Both flight chambers were oriented north to south in a shaded greenhouse at the USDA-ARS-SJVASC in Parlier, Calif. maintained at 20-30° C. and 60±5% RH. Each chamber was fitted with a Dayton blower (Model #4C119, Grainger, Lake Forest, Ill.) powered by an 1118.55-W motor that drew air through the flight chamber and vented the exhaust external to the greenhouse. The air intake end of the flight chambers was furnished with three charcoal filters and one Filtrete (trademark of 3M, St. Paul, Minn.) air filter (61×61×2.5 cm) (1900 MPR or 13 MERV rating) which was duplicated on the exhaust end of the chambers. Release platforms consisting of ring stands with adjustable angle flat-clamps were placed centrally 0.4 m from the rear and above the floor of each chamber. Each trap was suspended in the flight-tunnel via 30.5-cm long length of L-shaped 5.0-mm (I.D.) Pyrex® (trademark of Corning Incorporated, Corning, N.Y.) glass tubing with a 5.0 mm (I.D.) that penetrated a polyethylene bulkhead 22.8 cm from the edge of the lateral chamber walls and 25 cm downwind from the air intake. The glass tub was connected to the rear of polystyrene molded plastic cylinder by a threaded polyethylene connector. A double-sided yellow sticky card (Alpha Scents, Portland, Oreg.) cut to 38×70 mm was inserted into each trap to immobilized insects. Finally, each trap was sealed with a lid having a 9.5-mm hole drilled centrally to allow passage of the volatile-containing airstreams into the flight chamber.

Volatile Collection and Delivery System. A modified volatile collection and delivery system was attached to both flight chambers. Airflow was supplied by a compressor at 410 kPa and was pushed through two Varian Chrompack Gas-Clean moisture filters (Model #CP17971), an activated carbon filter, a water-filled 500-mL gas washing bottle, and a 6-channel air delivery system (ARS, Gainesville, Fla., Model #VCS-ADS-6AFM6C) in series. Each of two channels allowed a 1.5 L/min airflow, which was directed through 6.35-mm polytetrafluoroethylene flex-tubing to the inlet port of separate volatile collection tubes (ARS, Gainesville, Fla., Model #RV-A3). Each collection tube contained either almonds having recently initiated hull-split, or a subset of the same batch of almonds treated with a 0.01% aqueous solution of PLA.

PLA solution was applied to almonds using a spray-chamber having a 30.5-cm diameter platform rotated at 36 rpm within an enclosed cylindrical spray box. The 50 mL reservoir was loaded with 5 mL of the PLA mixture and the spray was delivered with 30 psig of nitrogen gas through a full cone model TG 0.4 fog nozzle (Spraying Systems Co., Wheaton, IL) positioned 61 cm above the center of the platform. For uniform spray coverage, as determined in preliminary experiments, almonds were localized radially 13 cm from center on the platform. Treated almonds were dried in air for 1 hour, and transferred to the volatile collection tube. Airflow exited each collection tube through two exit ports (exit ports 3 & 4 of each tube were plugged) and was directed through polytetrafluoroethylene flex-tubing to the glass rod of each trap on each flight chamber. In this manner, each flight chamber simultaneously received equal quantities of almond volatiles from each collection tube for pairwise comparisons.

Flight Bioassays. Two different types of flight bioassays were performed, designated as test type A and test type B.

In test type A, repellency of PLA toward female NOW was proxied by a reduction in the number of females captured in traps emitting volatiles from PLA-treated almonds relative to the number of females captured in traps emitting volatiles from non-treated almonds. Eighteen mated female NOW (>7 d old) were aspirated from the rearing colony and evenly separated into two 55.5 mL polystyrene vials, which were then capped and clamped to the release platforms 1 h prior to connecting the air delivery system to the flight chamber. Wind speed in the flight chambers was adjusted to 0.4±0.31 m/s to optimize flight conditions as well as volatile plume delivery. The vials were clamped to the platforms oriented upwind at 45 degrees from horizontal and then the caps were removed allowing the NOW to move freely within the flight chambers for 18 h (e.g., from 1500 to 0900 hours). Subsequently, traps were collected, the number of females immobilized in respective traps were counted and recorded, and flight chambers cleaned with a methanolic aqueous solution before the next trial. Test almonds, both PLA-treated and non-treated, were left in the volatile collection tubes between trials and cohorts of females were introduced and assayed each day as described above, for seven consecutive days. The test type A bioassay was replicated (n=2).

In test type B, repellency of PLA toward female NOW was proxied by a reduction in the number of eggs laid on a snare emitting volatiles from PLA-treated almonds relative to the number of eggs laid on a snare emitting volatiles from non-treated almonds. Each egg snare (Suterra LLC, Bend, Oreg., product #14990) was a 30.5 cm long Pyrex glass tube with a 5.0 mm (I.D.) connected to the top of a 111 mL black polystyrene molded plastic cylinder by a threaded polyethylene connector. NOW females oviposit eggs in the approximately 1.5 mm wide concentric groves of the cylindrical snare. Each snare was suspended in each tunnel as described above. After a flight period of 18 h (e.g., 1500 to 0900 hours), snares were collected, the number of laid eggs in respective snares were counted and recorded, and flight chambers prepared as above for the next trial. The chronology and replication of tests were as above.

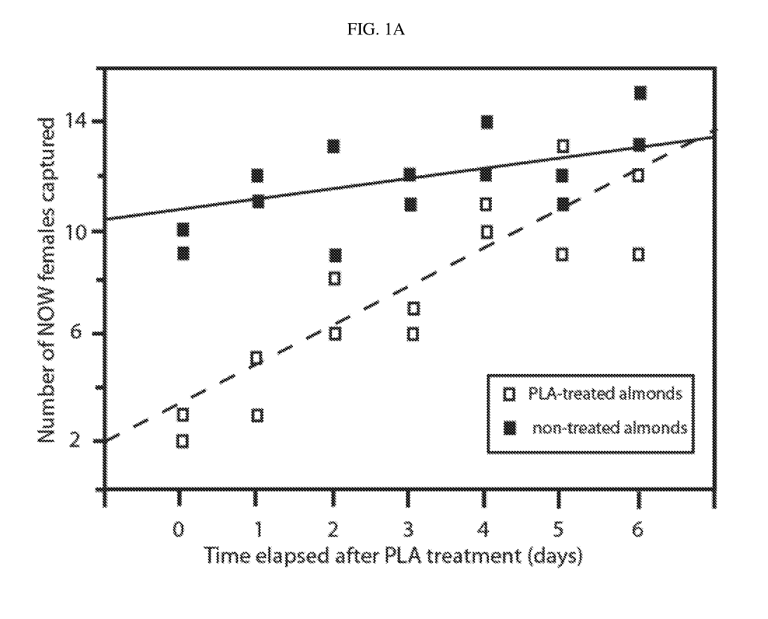

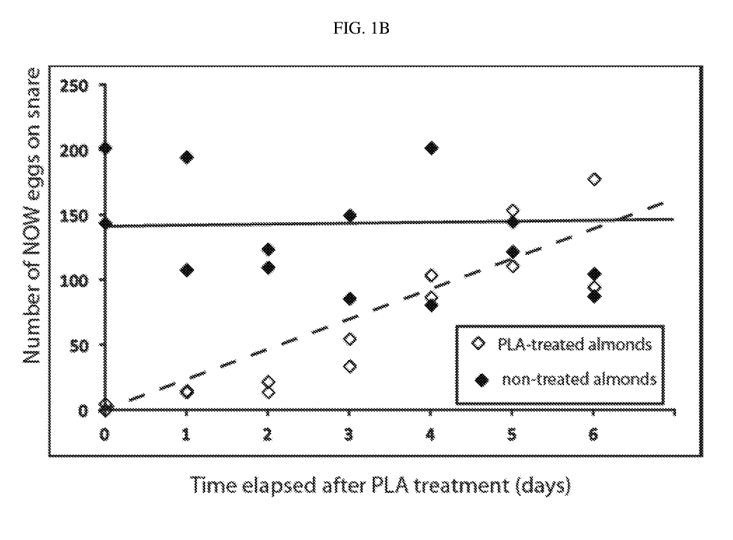

Based on counting the number of trapped females, there was surprisingly a significant difference in response to volatiles emitted from almonds undergoing hull-split when treated with PLA (Paired T-test, T₁₃=−9.1009, P>|t|=0.0001) relative to non-treated almonds, regardless of the time of testing. The mean response to non-treated almonds was 11.7 NOW/trial, while the response to PLA-treated almonds was 7.6 NOW/trial. Additionally, the duration between PLA treatment and the bioassay affected the response, as female trap-capture increased on PLA-treated almonds as they aged, approaching the trap capture observed for non-treated almonds. Differences in response were strongest within 96 h following treatment and approached parity thereafter. (PLA-treated linear fit, r²=0.79, F_{1,13}=7.859, P=0.0141; non-treated linear fit, r²=0.55, F_{1,13}=6.343, P=0.0246) (See FIG. 1A).

Based on counting the number of eggs laid by females in snares, there was surprisingly a significant difference in response to volatiles emitted from almonds undergoing hull-split when treated with PLA (Paired T-test, T₁₃=−3.229, P>|t|=0.0065) relative to non-treated almonds, regardless of the time of testing. The mean response to non-treated almonds was 133 eggs across all trials, while the average response to PLA-treated almonds was 63.4 eggs. Additionally, the duration between PLA treatment and the bioassay affected the response, as egg laying increased on PLA-treated almonds as they aged, approaching the trap capture observed for non-treated almonds. Again, differences in response were strongest within 96 h following treatment and approached parity thereafter (FIG. 1B).

### Example 2

### Asian Citrus Psyllid

In this example, the effectiveness of PLA was tested as a repellant against a Asian Citrus Psyllid, Diaphorina citri, (ACP), which transmits citrus greening disease (also known as Huanglongbing or HLB) caused by Candidatus liberibacter and is regulated as a quarantine pest in the United States. In particular, two-choice tests were conducted to determine the preference for ACP to reside, and presumably feed, on orange trees. Results provide evidence that citrus saplings treated with aqueous solutions of PLA were less likely to serve as a host for ACP, and that the likelihood surprisingly decreased as the percentage of aqueous PLA increased over the range 0.001 to 1.0%.

Insects. ACP adults were maintained on small orange trees in 75×75×115 cm fine mesh insect rearing tents (Model: BugDorm-2400F, MegaView Science Co. Ltd., Taiwan). Insects were collected from the cages using a mouth aspirator. Approximately 75 adults were released into a 5 ft³ fine mesh enclosure containing two orange saplings with either 0, 0.001, 0.01, 0.1, or 1% (v/v) aqueous solutions of PLA applied via Glass Chromatographic Reagent Atomizer (Corning, Inc. part #2153125) until the leaf surfaces were covered (as determined by visual inspection). After 48 h the location of the adults respective to the two seedlings was evaluated, and was recorded as a probability of host preference.

Two-choice Studies (C-Score). Two-choice studies involve three or more potential hosts each matched pairwise against one another (e.g., A:B, B:C, A:C). It is not uncommon in paired events involving more than two hosts, for situations to arise where, for example, A is preferred over B, and B over C, but where C is preferred over A. To accommodate these situations and to determine which host is most likely preferred, a method was developed for two-choice or pairwise studies that results in a C-score. Initially, all unexamined hosts begin with a default C-score, C=900. C-scores change after differences in preference probabilities are evaluated, as described below, for each pairing of potential hosts (A and B, B and C, etc.).

The actual preference probability for Host A, Aₐ, is calculated using Equation 1.

$${A}_{a} = \frac{( {P}_{a} + 0.5 {T}_{a} )}{n} \qquad ( Equation 1 )$$

Where Pₐ is the number of times host A was preferred over host B in n pairwise trials, and Tₐ is the number of occasions where no preference was observed (equal responses). Note that all variables pertaining to Host A are denoted by a subscripted “a,” and Host B by a subscripted “b.”

The expected preference probability for Host A, Eₐ, is calculated from Equation 2.

$${E}_{a} = \frac{1}{1 + {10}^{( \frac{{C}_{b} - {C}_{a}}{400} )}} \qquad ( Equation 2 )$$

Where C_{b} is the current C-score of host B, and Cₐ is the current C-score of host A. Thus, if the C-scores are equivalent, the expected probability for host A preference is 0.50. If C_{b}-Cₐ>400 the expected preference probability (Ea) for host A is limited to 0.08, or an 8% chance of host A being favored; likewise, if C_{b}-Cₐ<−400, Eₐ is capped at 0.92 to reflect the lack of absolute certainty due to chaos inherent in biological systems (Skinner, J. E., Low-Dimensional Chaos in Biological Systems, Nat Biotechnol, 12: 596-600 (1994)).

Once the actual and expected preference probabilities are calculated, the C-score for each potential host can be derived using a modified Elo-rating formula (Elo, A. E., The Rating of Chessplayers, Past and Present, Arco Pub (1978)) that takes the number of pairwise events into consideration (Equation 3).

C₁=C₀+(√n·K)(Aₐ−Eₐ) (Equation 3)

Where Co is the C-score of host A prior to the pairwise combination, n is the number of pairwise events evaluated between host A and B, K is a constant determined by the K-factor table (Table 1—Showing the minimum C-scores and the corresponding K-factor for two-choice studies. All untested hosts initially begin with a C-score=900 and K-factor=36 prior to being evaluated against another host.), Aₐ is the actual preference probability of host A in the pairwise combination A:B (from Equation 1), and Eₐ is the expected preference probability of host A when paired with B (from Equation 2). The K-factor term represents the number of points available to host A (adjusted by the number of trials) for increasing or decreasing its C-score. After calculation, Ci becomes the new C-score for host A and should be used in the subsequent pairwise calculation. Note that the C-score for host B must be calculated separately in the same manner.

TABLE 1
C-Scores & K-Factors

| Min C-Score | K-Factor |
|---|---|
| 100 | 5 |
| 162 | 7 |
| 222 | 10 |
| 278 | 12 |
| 329 | 14 |
| 377 | 16 |
| 420 | 18 |
| 460 | 19 |
| 496 | 21 |
| 530 | 23 |
| 560 | 24 |
| 588 | 25 |
| 614 | 27 |
| 638 | 28 |
| 660 | 29 |
| 680 | 30 |
| 699 | 31 |
| 718 | 32 |
| 735 | 33 |
| 752 | 34 |
| 786 | 35 |
| 840 | 36 |
| 900 | 36 |
| 986 | 35 |
| 1092 | 34 |
| 1180 | 33 |
| 1230 | 32 |
| 1284 | 31 |
| 1343 | 30 |
| 1407 | 29 |
| 1475 | 28 |
| 1549 | 27 |
| 1629 | 25 |
| 1715 | 24 |
| 1806 | 23 |
| 1905 | 21 |
| 2009 | 19 |
| 2121 | 18 |
| 2240 | 16 |
| 2367 | 14 |
| 2501 | 12 |
| 2643 | 10 |
| 2794 | 7 |
| 2953 | 5 |

To prevent scores from attaining a negative value, a floor of C=100 was established. No maximum value was set for C-scores. To limit potential variation in scores due to pairing order, the host with the highest overall actual preference probability, A, (designated as Host 1) was initially paired with the host that had the lowest overall actual preference probability, and Equation 3 was used to calculate the scores for each host. Subsequently, Host 1 was matched with the host possessing the second lowest actual preference probability (A) and C-scores were calculated for both hosts, until Host 1 was paired with every host in the study (and C-scores calculated). Computation proceeded as above, sans Host 1, for the host with the second highest actual preference probability (Host 2). Evaluation continued until the two least preferred hosts were paired. C-scores for each host were then used to assign rank.

Statistics of Ranking. For the no-choice study involving larval performance (D-score) an ANOVA, or if appropriate, a Welch's ANOVA, was used to rank each host based on the mean responses for each host. If the ANOVA was significant a Tukey-Kramer HSD with α=0.05 was used to establish rank. An algorithm was written in C++ (Microsoft Visual C++, 2010) to evaluate pairing order effects on C-scores using Equation 3 and dummy data sets for a specified number of host pairings with fixed differences in host preference. The number of hosts in the dummy data set was varied from 2 to 10 and the number of paired comparisons (i.e., assays) was varied from 5 to 50. For each combination of hosts and pairwise assays, C-scores for each host were calculated for 100 random iterations. Quantifying the variation in C-scores based on paring order, number of hosts, and number of pairwise assays was used to estimate these effects on the generation of final scores. Due to the multiplicative nature of the n term in Equation 3, variation in C-scores increased directly with number of pairwise assays.

Two-Choice Study (C-Score): Feeding Deterrent Bioassay. A minimum of 3 replicate trials was conducted for each pairwise combination. ACP location differed depending on host. No PLA treatment had the highest actual preference probability (A₀%=0.845), followed by decreasingly lower probabilities as the % of PLA in the aqueous solution increased. The C-scores, ranks, and preference probabilities are shown in Tables 2 and 3. For Table 3, actual preference probabilities for ACP host A (column) when simultaneously exposed to host B (row).

TABLE 2
Relative Host Preference

| Host ([PLA]_{aq.}) | 0.0% | 0.001% | 0.01% | 0.1% | 1.0% |
|---|---|---|---|---|---|
| C-score | 1805.4 | 986.2 | 835.87 | 224.3 | 104.5 |
| Rank | 1 | 2 | 3 | 4 | 5 |

TABLE 3
Actual Preference Probabilities

| Host | 0.0% | 0.001% | 0.01% | 0.1% | 1.0% |
|---|---|---|---|---|---|
| 0.0% | | 0.311 | 0.185 | 0.101 | 0.025 |
| 0.001% | 0.689 | | 0.375 | 0.347 | 0.051 |
| 0.01% | 0.815 | 0.653 | | 0.485 | 0.064 |
| 0.1% | 0.899 | 0.515 | 0.625 | | 0.375 |
| 1.0% | 0.975 | 0.949 | 0.936 | 0.625 | |
| Overall | 0.845 | 0.607 | 0.530 | 0.389 | 0.128 |

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments and characteristics described herein and/or incorporated herein. In addition the invention encompasses any possible combination that also specifically excludes any one or some of the various embodiments and characteristics described herein and/or incorporated herein.

The amounts, percentages and ranges disclosed herein are not meant to be limiting, and increments between the recited amounts, percentages and ranges are specifically envisioned as part of the invention. All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10 including all integer values and decimal values; that is, all subranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. As used herein, the term “about” refers to a quantity, level, value, or amount that varies by as much as 30%, preferably by as much as 20%, and more preferably by as much as 10% to a reference quantity, level, value, or amount.

The term “consisting essentially of” excludes additional method (or process) steps or composition components that substantially interfere with the intended activity of the method (or process) or composition. This term may be substituted for inclusive terms such as “comprising” or “including” to more narrowly define any of the disclosed embodiments or combinations/sub-combinations thereof.

“Optional” or “optionally” means that the subsequently described event or circumstance may or may not occur, and that the description includes instances in which said event or circumstance occurs and instances where it does not. For example, the phrase “optionally comprising a defoaming agent” means that the composition may or may not contain a defoaming agent and that this description includes compositions that contain and do not contain a foaming agent.

By the term “effective amount” of a compound or property as provided herein is meant such amount as is capable of performing the function of the compound or property for which an effective amount is expressed. As is pointed out herein, the exact amount required will vary from process to process, depending on recognized variables such as the compounds employed and various internal and external conditions observed as would be interpreted by one of ordinary skill in the art. Thus, it is not possible to specify an exact “effective amount,” though preferred ranges have been provided herein. An appropriate effective amount may be determined, however, by one of ordinary skill in the art using only routine experimentation.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims. Although any methods and materials similar or equivalent to those described herein can be used in the practice or testing of the present invention, the preferred methods and materials are herein described. Those skilled in the art may recognize other equivalents to the specific embodiments described herein which equivalents are intended to be encompassed by the claims attached hereto.

1. A method of repelling at least one insect pest, the method comprising applying to an object or area an amount of a repellant composition comprising greater than 0.0125% to about 10% (v/v) pyroligneous acid and optionally combining the repellant composition with a carrier, whereby the effective amount of the repellant composition is effective to reduce the at least one insect pest on the object or the area.

2. The method of claim 1, wherein the at least one insect pest comprises a plurality of insect species.

3. The method of claim 1, wherein the at least one insect pest comprises at least one insect species selected from the group consisting of: Diaphorina citri and Amyelois transitella.

4. The method of claim 1, wherein the at least one insect pest comprises at least one species or related species having common names selected from the group consisting of: psyllid, Asian citrus psyllid, and navel orangeworm.

5. The method of claim 1, wherein the area is a plurality of trees, plants, and/or harvest products in a setting selected from the group consisting of: an agricultural area; a harvest product transportation vessel or system; a harvest product storage area.

6. The method of claim 1, wherein the area is selected from the group consisting of: trees, citrus trees, nut trees, and harvest products.

7. The method of claim 1, wherein the repellant composition comprising pyroligneous acid is derived from the pyrolysis of a lignocellulosic biomass and the exhaust smoke is passed through at least one condensing column.

8. The method of claim 1, wherein the repellant composition comprising pyroligneous acid is derived from the pyrolysis of a lignocellulosic biomass and the exhaust smoke is passed through at least two condensing columns.

9. (canceled)

10. The method of claim 1, wherein the effective amount of the repellant composition comprising pyroligneous acid comprises greater than 0.0125% to about 1% (v/v) pyroligneous acid diluted in water.

11. The method of claim 1, further comprising: (a) subjecting a lignocellulosic biomass to a pyrolysis process and passing an exhaust gas of the pyrolysis process through at least one condensing column thereby producing a pyroligneous acid composition; (b) determining a concentration of pyroligneous acid within the produced pyroligneous acid composition; (c) diluting the pyroligneous acid composition in water to result in the concentration of pyroligneous acid thereby producing the repellant composition.

12. A method of protecting a tree, a plant, or a harvest product from acquiring a pathogen carried by an insect, the method comprising: treating at least one surface of the tree with an aqueous dilution of a repellant composition comprising pyroligneous acid greater than 0.0125% to about 10% by volume.

13. The method of claim 12, wherein the aqueous dilution of the repellant composition comprises an amount of pyroligneous acid sufficient to repel the insect to prevent transfer of the pathogen from the insect to the tree, the plant, or the harvest product.

14. (canceled)

15. The method of claim 12, wherein the effective amount of the repellant composition comprising pyroligneous acid comprises greater than 0.0125% to about 1% (v/v) pyroligneous acid diluted in water.

16. The method of claim 12, wherein the pathogen is selected from the group consisting of: Candidatus Liberibacter asiaticus, Alternaria alternata, Botrytis cinerea, Fusarium spp., Stemphylium spp., Penicillium spp., Cladosporium herbarum, and Aspergillus spp.

17. A method for protecting a tree or a harvest product of the tree from acquiring a plant pathogen carried by at least one insect, the method comprising: (a) subjecting a lignocellulosic biomass to a pyrolysis process and passing an exhaust gas of the pyrolysis process through at least one condensing column thereby producing a pyroligneous acid composition; (b) determining a concentration of pyroligneous acid within the produced pyroligneous acid composition; (c) diluting the pyroligneous acid composition in water to result in the concentration of pyroligneous acid greater than 0.0125% to about 10% (v/v) thereby producing an insect repellant composition; and (d) applying the insect repellant composition to at least one surface of the tree or the harvest product of the tree in an amount sufficient to repel the insect thereby preventing the tree or the harvest product of the tree from acquiring the plant pathogen.

18. The method of claim 17, wherein the tree is a citrus tree or a nut tree.

19. The method of claim 17, wherein the at least one insect is selected from the group consisting of: Asian citrus psyllid and navel orangeworm.

20. The method of claim 17, wherein the plant pathogen causes citrus-greening disease.

21. The method of claim 17, wherein the concentration of pyroligneous acid is greater than 0.0125% to about 1% (v/v).
